(19) United States
(12) Patent Application Publication
(10) Pub. No.: US 2011/0081894 A1
(43) Pub. Date: Apr. 7, 2011

(54) SYSTEM AND METHOD FOR PROVIDING UBIQUITOUS SERVICE USING MOBILE TERMINAL EQUIPMENT

(75) Inventors: Jung-Su SHIN, Seoul (KR); Kwang-ho KIM, Seoul (KR); Sung Wan Ju, Seoul (KR)

(73) Assignee: KOREA GEOSPATIAL INFORMATION & COMMUNICATION CO., LTD., Seoul (KR)

(21) Appl. No.: 12/756,721

(22) Filed: Apr. 8, 2010

(30) Foreign Application Priority Data
Oct. 7, 2009 (KR) 10-2009-0094904

(51) Int. Cl. H04M 3/42; H04W 4/00; H04Q 5/22

(52) U.S. Cl. 455/414.1; 455/466; 340/10.1

(57) ABSTRACT

There is provided a ubiquitous service providing system using a mobile communication terminal, the system including: a context aware unit determining where a ubiquitous service is to be provided or not through short message service (SMS) or multimedia messaging service (MMS) by analyzing radio frequency identification (RFID) tag information and context transmitted from an RFID identifier installed at a specific position; a repository unit storing the ubiquitous service to be provided, and contents and detailed information related to the ubiquitous service; an analyzing unit selecting a ubiquitous service from the repository unit based on the analyzed RFID tag information and context; a message generating unit generating final contents to be transmitted to a visitor using context and the contents and detailed information of the repository unit by executing the ubiquitous service selected by the analyzing unit and then, converting the final contents into a message to be transmitted through a SMS or MMS method; and a message transmitting unit transmitting the generated message to a mobile terminal of a visitor via a mobile phone network through a SMS or MMS method. There is provided a ubiquitous service providing method using a mobile phone network, the method including: once RFID tag information is collected by an RFID identifier, transmitting the collected RFID tag information and context to a u-City server; determining whether a ubiquitous service is to be provided or not based on the transmitted RFID tag information; if a ubiquitous service is to be provided, selecting a ubiquitous service to be provided based on the RFID tag information and context; generating final contents to be provided to a visitor using context and contents and detailed information of a repository unit by executing the selected ubiquitous service and converting the final contacts into a message to be transmitted through a SMS or MMS method; and transmitting the converted message through a SMS or MMS method.

CROSS-REFERENCE TO RELATED PATENT APPLICATION

This application claims the benefit of Korean Patent Application No. 10-2009-0094904, filed on Oct. 7, 2009, in the Korean Intellectual Property Office, the disclosure of which is incorporated herein in its entirety by reference.

### BACKGROUND OF THE INVENTION

1. Field of the Invention

The present invention relates to a system and method of providing a ubiquitous service using mobile terminal equipment, and a system and method of providing a ubiquitous service using mobile terminal equipment that visitors carry at various places such as an exhibition hall, a fair, and a seminar and allows the visitors to be provided with the most appropriate ubiquitous service at a current location only with a simple function such as short message service (SMS) or multimedia messaging service (MMS) even if additional application installation is unavailable.

2. Description of the Related Art

In general, in a case of an exhibition hall or a fair where visitors watch or appreciate a variety of items displayed or traded, the visitors always attempt to find the best efficient time spending.

As one of those attempts, typically provided is a method of providing a brochure including a map of an exhibition hall or a fair and brief description about displayed items.

However, this method has limitations at places such as an exhibition hall and a fair in an aspect of simple information transmission, where visitor utilization is low and information related to a visitor's schedule is not provided.

Thus, as information communication and IT technologies are developed and incorporated, the above limitations may be resolved by providing a ubiquitous service fitting for a variety of situations of a visitor.

However, in order to use a newly-introduced ubiquitous service, a visitor must carry a mobile terminal that supports an application capable of executing the ubiquitous service.

In reality, only some of visitors carry a mobile terminal that supports an application for a ubiquitous service and most of the visitors carry a mobile terminal that supports a simple function such as a typical SMS or MMS.

As a result, even though information communication and IT technologies are developed and thereby ubiquitous services are being actively distributed, because a terminal of a visitor usually does not support an application for a ubiquitous service, there are difficulties in spreading the ubiquitous service.

Therefore, required is a method of providing a ubiquitous service to visitors with typical terminals (so-called “feature phones”, “non-smart phones”).

### SUMMARY OF THE INVENTION

The present invention provides a system and method of providing a ubiquitous service using a mobile communication terminal, which provides an appropriate ubiquitous service to a visitor using short message service (SMS) and multimedia messaging service (MMS) functions in a mobile terminal of a visitor where an additional application installation is unavailable at a place such as an exhibition hall.

The present invention also provides a system and method of providing a ubiquitous service, which provides the most appropriate ubiquitous service to a visitor using SMS or MMS by analyzing radio frequency identification (RFID) information and peripheral context identified by an RFID tag that a visitor carries.

According to an aspect of the present invention, there is provided a ubiquitous service providing system using a mobile communication terminal, the system including: a context aware unit determining where a ubiquitous service is to be provided or not through short message service (SMS) or multimedia messaging service (MMS) by analyzing radio frequency identification (RFID) tag information and context transmitted from an RFID identifier installed at a specific position; a repository unit storing the ubiquitous service to be provided, and contents and detailed information related to the ubiquitous service; an analyzing unit selecting a ubiquitous service from the repository unit based on the analyzed RFID tag information and context; a message generating unit generating final contents to be transmitted to a visitor using context and the contents and detailed information of the repository unit by executing the ubiquitous service selected by the analyzing unit and then, converting the final contents into a message to be transmitted through a SMS or MMS method; and a message transmitting unit transmitting the generated message to a mobile terminal of a visitor via a mobile phone network through a SMS or MMS method.

The system may further include an information collecting unit delivering context to the context aware unit.

The RFID identifier may include: an RFID reader unit collecting RFID tag information; and a control unit filtering the RFID tag information and then transmitting the filtered RFID tag information to the context aware unit.

The RFID tag information may be personal information including a name, an address, an age, a job, and a phone number of a visitor.

The message transmitting unit may transmit the ubiquitous service to a phone number of a visitor searched from the RFID tag information.

According to another aspect of the present invention, there is provided a ubiquitous service providing method using a mobile phone network, the method including: once RFID tag information is collected by an RFID identifier, transmitting the collected RFID tag information and context to a u-City server; determining whether a ubiquitous service is to be provided or not based on the transmitted RFID tag information; if a ubiquitous service is to be provided, selecting a ubiquitous service to be provided based on the RFID tag information and context; generating final contents to be provided to a visitor using context and contents and detailed information of a repository unit by executing the selected ubiquitous service and converting the final contacts into a message to be transmitted through a SMS or MMS method; and transmitting the converted message through a SMS or MMS method.

The determining of whether the ubiquitous service is to be provided or not may be determined based on a phone number of a visitor included in the RFID tag information.

The determining of whether the ubiquitous service is to be provided or not may include determining that the ubiquitous service is not to be provided when there is no phone number of a visitor or SMS or MMS transmission is unavailable.

The context may include a position of the RFID identifier.

### BRIEF DESCRIPTION OF THE DRAWINGS

The above and other features and advantages of the present invention will become more apparent by describing in detail exemplary embodiments thereof with reference to the attached drawings in which:

FIG. 1 is a conceptual view illustrating a ubiquitous service providing system using a mobile communication terminal according to the present invention;

FIG. 2 is a conceptual view illustrating a ubiquitous service providing system using a mobile communication terminal according to a first embodiment;

FIG. 3 is a conceptual view illustrating a ubiquitous service providing system using a mobile communication terminal according to a second embodiment;

FIG. 4 is a view illustrating an example of a u-Service according to the present invention;

FIG. 5 is a view illustrating a first embodiment of a ubiquitous service providing method using a mobile communication terminal according to the present invention;

FIG. 6 is a view illustrating a second embodiment of a ubiquitous service providing method using a mobile communication terminal according to the present invention; and

FIG. 7 is a view illustrating a third embodiment of a ubiquitous service providing method using a mobile communication terminal according to the present invention.

### DETAILED DESCRIPTION OF THE INVENTION

Hereinafter, preferred embodiments will be described in more detail with reference to the accompanying drawings. Moreover, detailed descriptions related to well-known functions or configurations will be ruled out in order not to unnecessarily obscure subject matters of the present invention.

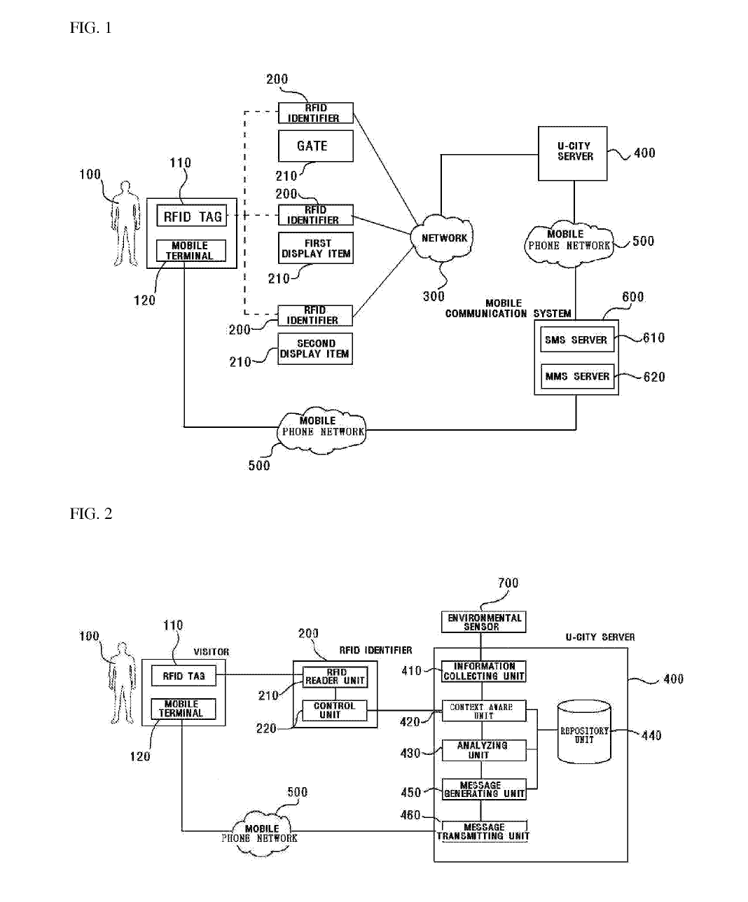

FIG. 1 is a conceptual view illustrating a ubiquitous service providing system using a mobile communication terminal according to the present invention.

As shown in FIG. 1, the ubiquitous service providing system using a mobile communication terminal includes a radio frequency identification (RFID) tag 110 and a mobile terminal 120 that a visitor 100 carries, an RFID identifier installed at a special position such as an exhibition hall, a u-City server 400, and a mobile communication system 600. The RFID identifier 200 is connected to the u-City server 400 via a network 300. The u-City server 400 is connected to a mobile communication system 600 via a mobile phone network 500.

In more detail, the visitor 100 has the RFID tag 110 and the mobile terminal 120 and watches preferred items while moving to a specific position of an exhibition hall.

At this point, the RFID identifier 200 installed at a specific position of an exhibition hall identifies the RFID tag 110 that the visitor 100 carries to collect RFID tag information and transmits the collected RFID tag information and context to the u-City server 400 via the network 300.

Here, the RFID identifier 200 may be installed at various places such as an exhibition hall. For example, the RFID identifier 200 may be installed at a gate or around each item of an exhibition hall.

The u-City server 400 selects a ubiquitous service (that is determined necessary for the visitor 100 or that the visitor 100 requests) based on the transmitted RFID tag information and context and then, transmits the selected ubiquitous service to the mobile terminal 120 of the visitor 100 via the mobile communication system 600 using SMS or MMS.

Here, SMS is an acronym standing for short message service and MMS is an acronym standing for multimedia message service.

However, according to the ubiquitous service providing system using a mobile communication terminal, there is a feature that the SMS and MMS use already-existing methods.

FIG. 2 is a conceptual view illustrating a ubiquitous service providing system using a mobile communication terminal according to a first embodiment.

As shown in FIG. 2, the ubiquitous service providing system using a mobile communication terminal according to the first embodiment includes a visitor 100 having an RFID tag 110 and a mobile terminal 120, an RFID identifier 200 including an RFID reader unit 210 and a control unit 220, an information collecting unit 410, a context aware unit 420, an analyzing unit 430, a repository unit 440, a message generating unit 450, and a message transmitting unit 460. Hereinafter, each component will be described in more detail.

The visitor 100 has the RFID tag 110 and the mobile terminal 120. Here, the RFID tag 110 may include visitor identification (ID) information. The visitor ID information may be used as information to search personal information of the visitor 100. For example, once the visitor ID information is transmitted to the u-City server 400 through the RFID identifier 200, the u-City server 400 uses the visitor ID information to search personal information of the visitor 100. The personal information of the visitor 100 includes information such as a name, an address, an age, a job, a phone number, etc.

Of course, the RFID tag 100 may directly include personal information not a form of the visitor ID information.

In a case that the visitor 100 can carry the mobile terminal 120, various devices may be used for the mobile terminal 120. However, the mobile terminal 120 needs to support an application that can provide a ubiquitous service (hereinafter, referred to as a u-Service) selected from the u-City server 400 through SMS or MMS. Of course, the mobile terminal 120 may support an application for providing various services besides SMS or MMS.

The RFID identifier 200 includes the RFID reader unit 210 and the control unit 220.

Here, the RFID reader unit 210 recognizes the RFID tag 110 when the visitor 100 is within a recognition range and then collects corresponding RFID tag information. Here, the RFID reader unit 210 may simultaneously recognize at least one visitor 100.

The control unit 220 filters RFID tag information received by the RFID reader unit 210. The filtering of the RFID tag information filters RFID tag information following the first when the same visitor 100 is continuously recognized.

In addition, the control unit 220 may transmit the received context besides the transmitting of the recognized RFID tag information to the u-City server 400. Here, the context may be variously applied. For example, the context may include information about a current position of the RFID identifier 200, information about whether a fire occurs or not by a thermal sensor, and information about the number of visitors.

The u-City server 400 selects a ubiquitous service (that is determined necessary for the visitor 100) based on the transmitted RFID tag information and context and then, transmits the selected ubiquitous service to the mobile terminal 120 of the visitor 100 through the mobile communication system 500 using SMS or MMS.

For this, the u-City server 400 includes the information collecting unit 410, the context aware unit 420, the analyzing unit 430, the repository unit 440, the message generating unit 450, and the message transmitting unit 460.

The information collecting unit 410 may collect other necessary context except for information transmitted from the RFID identifier 200 so as to select the u-Service to be transmitted. Context collected by the information collecting unit 410 may vary.

For example, context about the number of visitors may be selected from another RFID identifier to select the optimized route at a current position of the visitor 200. Accordingly, a visitor may move and watch popular display booths easily along the optimized route.

Additionally, a current position of another co-worker may be searched and also schedules of other co-workers may be compared by collecting RFID tag information of other co-worker.

The information collecting unit 410 is connected to an external sensor like an environmental sensor 700 and thus may collect context collected by the environmental sensor 700. For example, if a fire sensor is connected as an environmental sensor, the information collecting unit 410 may collect context on whether a fire incident occurs or not using the fire sensor. However, the environmental sensor 700 connected to the information collecting unit 410 may use various kinds of sensors if necessary.

The context aware unit 420 determines whether a u-Service is to be provided to the visitor 100 or not by identifying the RFID tag information and context transmitted from the RFID identifier 200 and the context collected by the information collecting unit 410.

The context aware unit 420 analyzes personal information of a visitor using RFID tag information and determines whether a u-Service needs to be provided or not based on the personal information of the visitor and information stored in the repository unit 440.

For example, if a visitor does not have a mobile phone number or there is no need to provide a u-Service to the visitor through SMS or MMS or there is no service that can be provided to the visitor at a current position and time, it is determined that the u-Service is not provided.

If it is determined by the context aware unit 420 that the u-Service needs to be provided to the visitor 100, the analyzing unit 430 selects a u-Service based on the personal information and context by the RFID tag information.

Here, the selected u-Service may vary according to a position, time, and context of a visitor and previously stored specific conditions.

Accordingly, each visitor may be provided with different u-Service at the same position and also, a necessary u-Service may be selected according to time and another context.

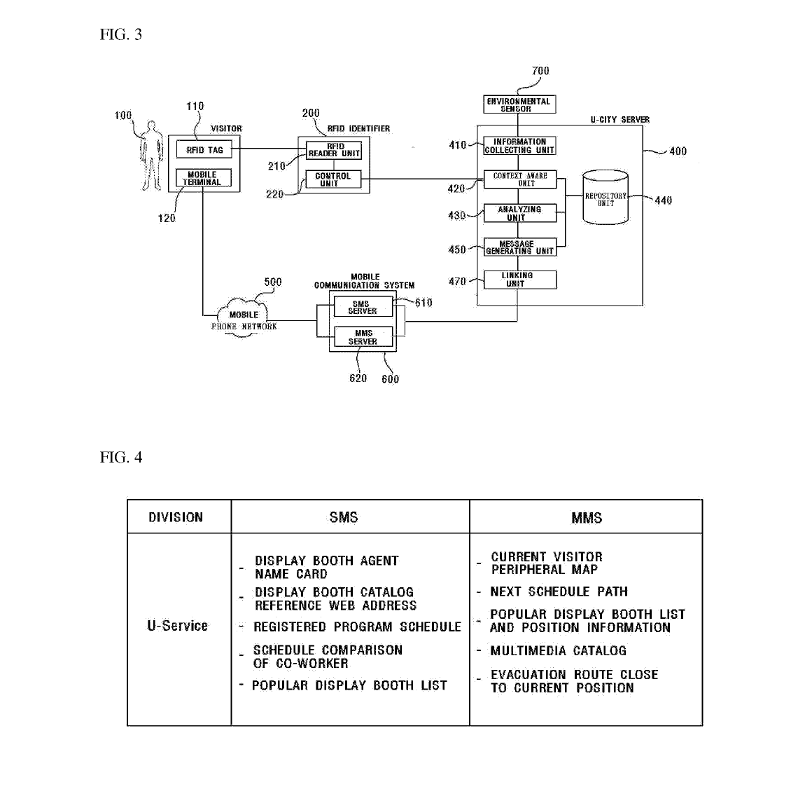

For example, by using the position information of the RFID identifier 200, position information of a schedule that is closest to a corresponding point of time among schedule information of the visitor 100 is combined with a map that is previously stored in the repository unit 440, such that a u-Service about a route of the next schedule can be selected. Service types provided as a u-Service will be introduced in FIG. 4.

Once the u-Service that will be provided is selected, the analyzing unit 430 delivers information about the selected u-Service to the message generating unit 450.

The repository unit 440 may store information about the RFID identifier 200, personal information of a visitor, an exhibition hall map, various information related to an exhibition hall (for example, information about display providers and information about companies participating in the display), and various contents necessary for providing a u-Service.

The information about the RFID 200 may be information about a position of each RFID identifier.

Personal information of a visitor may be confirmed through visitor ID information recognized by an RFID tag. Personal information of a visitor may include information about a name, an address, an age, and a job of the visitor.

Especially, the personal information of the visitor should include a number of the mobile terminal 120 of the visitor. However, if the RFID tag includes mobile phone number information, the personal information of a visitor may not include the mobile phone number information.

Moreover, the personal information of a visitor may include schedule information of the visitor.

The personal information of a visitor may be stored in advance before a visitor participates in an exhibition hall.

The message generating unit 450 executes the u-Service selected by the analyzing unit 430 and then generates a u-Service message in a format that is appropriate for transmission using SMS or MMS.

Specifically, the message generating unit 450 executes the u-Service selected from the analyzing unit 430 so as to generate final contents that will be delivered to a visitor using the context and the contents and detailed information of the repository unit and then converts the generated final contents into a message that can be transmitted using SMS or MMS.

For example, if a u-Service for searching a route of a visitor is provided, the route of a visitor is searched based on a current position and schedule information of the visitor, and then, contents where the route of a visitor is indicated are generated using map information stored in the repository unit 440. Next, a message that can be transmitted through SMS or MMS is generated.

Accordingly, without adding a separate application to a typical mobile terminal, the message generating unit 450 may appropriately modify the u-Service contents in order to provide the u-Service to the visitor.

The message transmitting unit 460 transmits the u-Service contents generated by the message generating unit 450 to the mobile terminal 120 of the visitor 100 via the mobile phone network 500 using SMS or MMS.

FIG. 3 is a conceptual view illustrating a ubiquitous service providing system using a mobile communication terminal according to a second embodiment.

As shown in FIG. 3, the ubiquitous service providing system using a mobile communication terminal according to the second embodiment does not generate a u-Service related message that will be transmitted unlike the first embodiment of FIG. 2, but generates the u-Service related message and transmit it using SMS or MMS if it is determined by an analyzing unit 430 that an existing mobile communication system 600 needs to be used.

Accordingly, if it is determined that a u-Service needs to be provided to a visitor, the analyzing unit 430 determines that a mobile terminal 120 of a visitor 100 directly supports an application for providing the u-Service or not in addition to the selecting of the u-Service, and then determines that the u-Service is provided to the mobile terminal directly or through the existing mobile communication system 600.

The analyzing unit 430 directly transmits the u-Service not via the existing mobile communication system 600 if the visitor 100 directly can execute the u-Service based on the RFID tag information (not shown).

However, if it is determined by the analyzing unit 430 that the mobile terminal 120 of the visitor 100 does not support an application and thus the existing mobile communication system 600 needs to be used, the message generating unit 450 executes a u-Service selected by the analyzing unit 430 and then generates a u-Service message in a format that is appropriate for transmission using SMS or MMS.

In more detail, the message generating unit 450 executes the u-Service selected by the analyzing unit to generate final contents that will be transmitted to the visitor using the context and the contents and detailed information of the repository unit and then converts the final contents to a message that can be transmitted using SMS or MMS.

A linking unit 470 transmits the u-Service message converted and generated by the message generating unit 450 to a SMS server 610 or an MMS server 620 of the existing mobile communication system 600.

Accordingly, once the u-Service contents are received from the linking unit 470, the SMS server 610 and the MMS server 620 transmit the received u-Service contents to the mobile terminal 120 of the visitor via a mobile phone network 500.

FIG. 4 is a view illustrating an example of a u-Service according to the present invention.

As shown in FIG. 4, it illustrates an example of the u-Service that can be provided using SMS or MMS without an additional application support, through which visitors may use the u-Service at an exhibition hall.

First, a name card of a display booth agent, a display booth catalogue reference web address, a registered program schedule, and a schedule comparison of a co-worker may be provided using the u-Service through a SMS method.

Next, a peripheral map of a visitor, the next schedule route, a list and position information of popular display booths, a multimedia catalogue, and an evacuation route close to a current position may be provided using the u-Service through a MMS method.

The above introduced u-Services are just examples and may be variously applied in some cases.

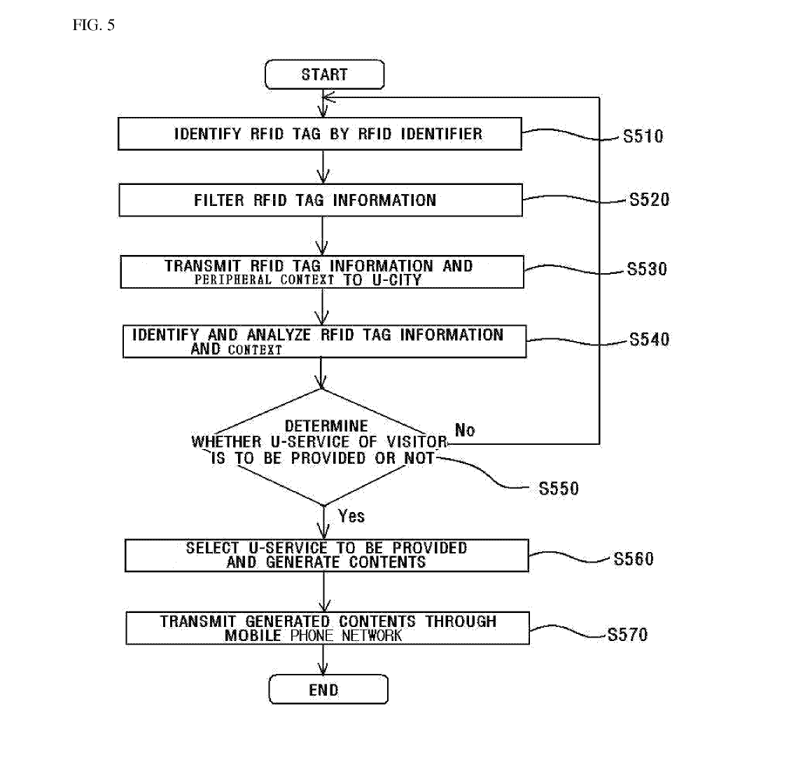

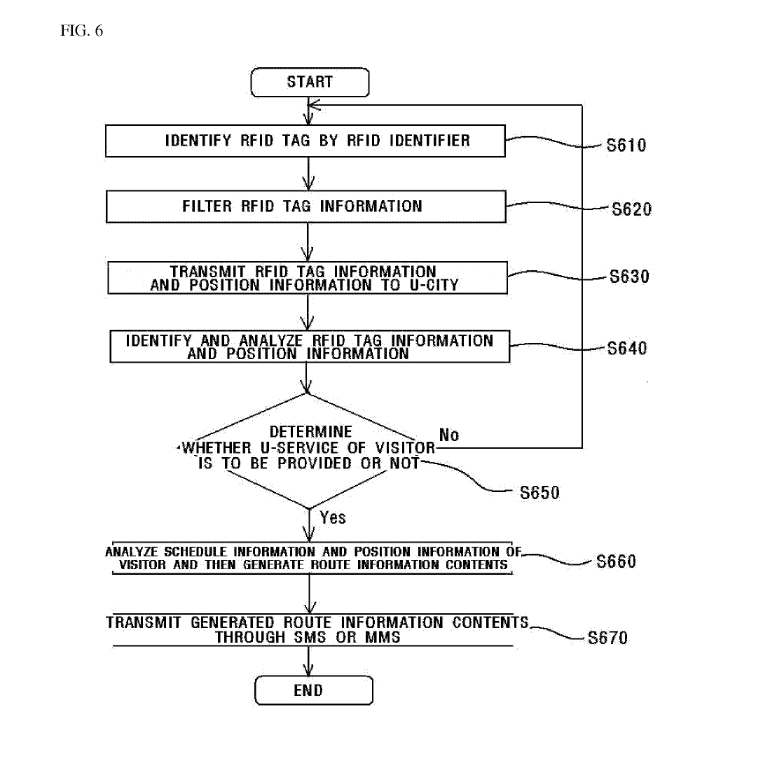

FIG. 5 is a view illustrating a first embodiment of a ubiquitous service providing method using a mobile communication terminal according to the present invention.

As shown in FIG. 5, the ubiquitous service providing method using a mobile communication terminal according to the first embodiment is performed using RFID tag recognition by an RFID identifier in operation S510.

The RFID identifier continuously recognizes whether there is an RFID tag according to a predetermined time or period.

Once the RFID tag is recognized by the RFID identifier, RFID tag information is collected.

Then, once the RFID tag information is collected, a control unit of the RFID identifier filters the RFID tag information in operation S520.

Here, if the same RFID tag information is continuously collected, it is determined that a u-Service necessary for a corresponding visitor is provided already and thus the filtering of the RFID tag information removes corresponding RFID tag information and collects another RFID tag information again.

Once the RFID tag information is collected by the RFID identifier, the collected RFID tag information and peripheral context are transmitted to a u-City server in operation S530.

Once the u-City server receives the RFID tag information and peripheral context, a context aware unit recognizes and analyzes the transmitted information in operation S540.

The context aware unit determines whether a u-Service is to be provided to a visitor or not based on the recognized RFID tag information and peripheral context and information stored in the repository unit in operation S550.

Here, the determining of whether the u-Service is to be provided or not includes determining that the u-Service cannot be provided if a mobile terminal of a visitor includes an installed application that may execute the u-Service not via the existing mobile communication system or there is no number of the mobile terminal of the visitor.

Accordingly, the RFID identifier performs an operation for recognizing an RFID tag continuously.

On the contrary, if a mobile terminal of a visitor may receive a u-Service through SMS or MMS, the u-City server selects a u-Service that will be provided, and then generates a u-Service contents message for transmitting the selected u-Service as a SMS or MMS message in operation S560.

Once the u-Service contents message for transmission using SMS or MMS is generated, the generated contents are transmitted via a mobile phone network in operation S570.

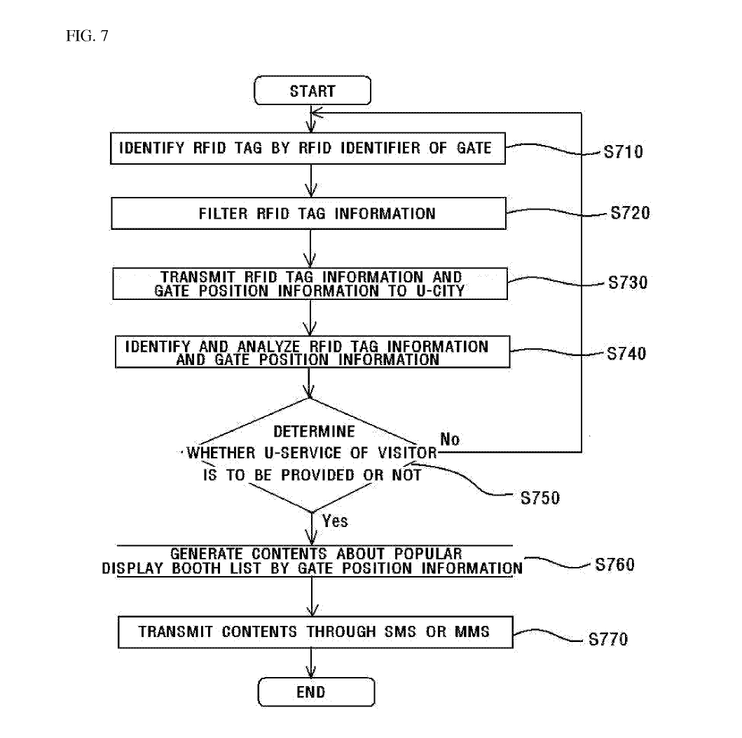

FIG. 6 is a view illustrating a second embodiment of a ubiquitous service providing method using a mobile communication terminal according to the present invention.

As shown in FIG. 6, the ubiquitous service providing method using a mobile communication terminal according to the second embodiment provides a u-Service based on a current position and schedule information of a visitor.

First, the RFID identifier recognizes an RFID tag of a visitor to collect corresponding RFID tag information in operation S610. The RFID identifier continuously recognizes whether there is an RFID tag or not according to a predetermined time or period. Then, the RFID identifier collects RFID tag information once the RFID tag is recognized.

Then, once the RFID tag information is collected, a control unit of the RFID identifier filters the RFID tag information in operation S620.

Once the RFID tag information is recognized by the RFID identifier, current position information of a visitor based on a position of the RFID identifier among the collected RFID tag information and peripheral context is transmitted to the u-City server in operation S630. However, the current position information of the visitor may be realized with various methods. For example, a current position of a visitor may be calculated by using a position of a current RFID identifier and also by measuring a distance of the RFID tag from the RFID identifier.

Then, the u-City server recognizes and analyzes the transmitted RFID tag information and the current position of the visitor in operation S640.

The u-City server analyzes the RFID tag information and current position information of a visitor to determine whether a u-Service is to be provided to a visitor or not in operation S650.

Here, if the u-Service does not necessarily need to be provided to a visitor or cannot be provided to a visitor, the above operations repeat again according to an operation of the RFID identifier.

Based on a determination result, if it is determined that a u-Service needs to be provided to a visitor via a mobile phone network using SMS or MMS, route information contents of a visitor are generated based on schedule information and position information of a visitor stored in a repository unit of the u-City server in operation S660.

Here, the route information may display a route from a current position to a position of the next schedule on an electronic map and also display information that a current moving speed of a visitor is slower than other visitors and a route that the visitor can join other visitors. Accordingly, route information contents may be variously realized.

The u-City server transmits the generated route information contents to the mobile terminal of the visitor via a mobile phone network using SMS or MMS in operation S670.

FIG. 7 is a view illustrating a third embodiment of a ubiquitous service providing method using a mobile communication terminal according to the present invention.

As shown in FIG. 7, the ubiquitous service providing method using a mobile communication terminal according to the third embodiment provides a method of providing a u-Service about a list and position of a popular display booth among display booths at an exhibition hall if an RFID tag of a visitor is recognized by an RFID identifier of a gate (that is, an entrance of an exhibition hall).

First, the RFID identifier recognizes an RFID tag of a visitor and then collects corresponding tag information in operation S710. The RFID identifier continuously recognizes whether there is an RFID tag or not according to a predetermined time or a regular period and then collects RFID tag information once the RFID tag is recognized.

Then, once the RFID tag information is collected, a control unit of the RFID identifier filters the RFID tag information in operation S720.

Once the RFID tag information is collected and filtered by the RFID identifier, the collected RFID tag information and peripheral context that a current RFID identifier is positioned at a gate are transmitted to a u-City server in operation S730.

The u-City server recognizes and analyzes the transmitted RFID tag information and gate position information in operation S740.

The u-City server analyzes the RFID tag information and gate position information and determines whether the u-Service is to be provided to a visitor or not in operation S750.

Based on a determination result, if the u-Service does not necessarily need to be provided to the visitor, the above operation repeats by continuously performing an operation of the RFID identifier.

Then, based on a determination result, if it is determined that the u-Services needs to be provided using SMS or MMS, the analyzing unit of the u-City server generates contents about a popular display booth list according to recognizing of a gate position information in operation S760.

Here, the generated popular display booth list may be realized by a method of displaying message information about the popular display booth list and popular display booths on a map of an exhibition hall also.

Once the contents about the popular display booth list are generated, they are transmitted to the mobile terminal of the visitor using SMS or MMS in operation S770.

The system and method of providing a ubiquitous service of the present invention provides a necessary ubiquitous service using a mobile terminal of a visitor even if new application is unavailable.

The system and method of providing a ubiquitous service of the present invention provides a ubiquitous service quickly using a basic infra at a place such as an exhibition hall.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A ubiquitous service providing system using a mobile communication terminal, the system comprising:
a context aware unit determining where a ubiquitous service is to be provided or not through short message service (SMS) or multimedia messaging service (MMS) by analyzing radio frequency identification (RFID) tag information and context transmitted from an RFID identifier installed at a specific position;
a repository unit storing the ubiquitous service to be provided, and contents and detailed information related to the ubiquitous service;
an analyzing unit selecting a ubiquitous service from the repository unit based on the analyzed RFID tag information and context;
a message generating unit generating final contents to be transmitted to a visitor using context and the contents and detailed information of the repository unit by executing the ubiquitous service selected by the analyzing unit and then, converting the final contents into a message to be transmitted through a SMS or MMS method; and
a message transmitting unit transmitting the generated message to a mobile terminal of a visitor via a mobile phone network through a SMS or MMS method.

2. The system of claim 1, further comprising an information collecting unit delivering context to the context aware unit.

3. The system of claim 1, wherein the RFID identifier comprises:
an RFID reader unit collecting RFID tag information; and
a control unit filtering the RFID tag information and then transmitting the filtered RFID tag information to the context aware unit.

4. The system of claim 1, wherein the RFID tag information is personal information including a name, an address, an age, a job, and a phone number of a visitor.

5. The system of claim 4, wherein the message transmitting unit transmits the ubiquitous service to a phone number of a visitor searched from the RFID tag information.

6. A ubiquitous service providing method using a mobile phone network, the method comprising:
once RFID tag information is collected by an RFID identifier, transmitting the collected RFID tag information and context to a u-City server;
determining whether a ubiquitous service is to be provided or not based on the transmitted RFID tag information;
if a ubiquitous service is to be provided, selecting a ubiquitous service to be provided based on the RFID tag information and context;
generating final contents to be provided to a visitor using context and contents and detailed information of a repository unit by executing the selected ubiquitous service and converting the final contacts into a message to be transmitted through a SMS or MMS method; and
transmitting the converted message through a SMS or MMS method.

7. The method of claim 6, wherein the determining of whether the ubiquitous service is to be provided or not is determined based on a phone number of a visitor included in the RFID tag information.

8. The method of claim 7, wherein the determining of whether the ubiquitous service is to be provided or not comprises determining that the ubiquitous service is not to be provided when there is no phone number of a visitor or SMS or MMS transmission is unavailable.

9. The method of claim 8, wherein the context comprises a position of the RFID identifier.
